(19) United States
(12) Patent Application Publication
(10) Pub. No.: US 2008/0279290 A1
(43) Pub. Date: Nov. 13, 2008

(54) Technique for Operating a Communication System at a Higher Spectral Utilization for Wireless Broadband Applications

(75) Inventor: Assad Radpour, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: AT&T KNOWLEDGE VENTURES, LP, Reno, NV (US)

(21) Appl. No.: 11/746,422

(22) Filed: May 9, 2007

(51) Int. Cl. H04L 27/28

(52) U.S. Cl. 375/260; 375/E07.021

(57) ABSTRACT

A technique of operating a communication system includes receiving a first communication signal that is assigned to a first frequency band that does not overlap with a second frequency band. The first communication signal is frequency translated to a second communication signal that falls within an available bandwidth in the second frequency band. Finally, the second communication signal is transmitted.

### FIELD OF THE DISCLOSURE

The present disclosure is generally directed to a communication system and, more particularly, to a technique for operating a communication system.

### BACKGROUND

Due to the expense required to implement landline communication systems, wireless communication systems have become an attractive alternative for providing communication services in many parts of the world. In general, wireless communication systems utilize allocated frequency bands to provide services to subscriber stations. For example, one of the first commercial mobile cellular communication systems in the United States was an analog system known as Advanced Mobile Phone System (AMPS), which utilized a frequency band between 824 and 894 MHz. The analog AMPS standard has essentially been replaced by digital standards, such as Global System for Mobile communications (GSM) and Universal Mobile Telecommunication System (UMTS). Typically, cellular systems employ subscriber stations, such as mobile telephones, that support multiple frequency bands. For example, a GSM subscriber station may be designed to support three frequency bands in the 850, 1800, and 1900 MHz bands. The actual frequency used by a particular subscriber station may vary from location to location, depending on settings of a base station for a particular carrier. In the United States, frequency usage is regulated by the Federal Communications Commission (FCC) and the United States is divided geographically into a number of trading areas. To obtain the right to use any portion of the frequency spectrum in a given trading area, a party is required to successfully bid on each trading area.

Recently, the Institute of Electrical and Electronics Engineers (IEEE) promulgated the IEEE 802.16 standard for wireless local and metropolitan area networks. The Worldwide Interoperability for Microwave Access (WiMAX) forum was formed to promote conformance and interoperability of IEEE 802.16 standard-based systems and devices. The IEEE 802.16 standard specifies a communication bandwidth between 2 and 66 GHz. Traditionally, implementing new technologies, such as systems that comply with the IEEE 802.16 standard, has required communication spectrum acquisition, as well as infrastructure design and installation. Unfortunately, acquiring communication spectrum, assuming the spectrum is available, and designing and installing infrastructure can be relatively expensive.

### BRIEF DESCRIPTION OF THE DRAWINGS

The present disclosure may be better understood, and its numerous features and advantages made apparent to those skilled in the art by referencing the accompanying drawings, in which:

FIG. 1 is a system block diagram of a wireless communication system that employs access adaptors configured according to the present disclosure;

FIG. 2 is a system block diagram of an access adapter configured according to an embodiment of the present disclosure; and

FIG. 3 is a flow chart of an adapter operation process implemented according to an embodiment of the present disclosure.

The use of the same reference symbols in different drawings indicates similar or identical items.

### DETAILED DESCRIPTION OF THE DRAWINGS

Telecommunication operators have been exploring various options for providing wireless broadband access, such as Internet access, to subscriber stations for a relatively long period of time. However, the lack of frequency spectrum and the cost of deploying wireless systems has delayed or prevented the implementation of wireless systems that provide broadband access to subscriber stations in many areas. Various embodiments of the present disclosure facilitate implementation of wireless broadband systems using existing infrastructure and frequency bands that have already been allocated (or are readily available) to telecommunication operators.

For example, in areas where a cellular band is not fully utilized, access adapters may be implemented to allow telecommunication operators to offer wireless broadband services via the cellular band. The implemented access adapters are configured to frequency translate a communication signal that is compliant with a first communication standard from a first frequency band, e.g., an unlicensed WiMAX band, to an available bandwidth in a second frequency band, e.g., a licensed cellular band, in which the telecommunication operator has existing rights or can readily acquire rights. Similarly, the access adapters are also configured to frequency translate a communication signal from the second frequency band to the first frequency band. In this manner, the cost associated with acquisition of additional frequency spectrum, as well as some infrastructure cost, may be avoided and bandwidth that was not already used in a frequency band may be utilized for broadband services, thus increasing the profitability of telecommunication operators as well as utilizing spectrum that was previously unused. As used herein, the term “coupled” includes both a direct electrical connection between elements (or blocks) and an indirect electrical connection between elements (or blocks) provided by one or more intervening elements (or blocks).

According to one disclosed embodiment, a technique of operating a communication system includes receiving a first communication signal that is assigned to a first frequency band (e.g., a WiMAX band) that does not overlap with a second frequency band (e.g., a cellular band). The first communication signal is frequency translated to a second communication signal that falls within an available bandwidth in the second frequency band. Finally, the second communication signal is transmitted.

According to another embodiment of the present disclosure, an access adapter for a communication system includes a first converter and a second converter. The first converter is configured to receive a first communication signal that falls within a first frequency band, frequency translate the first communication signal to a second communication signal that falls within a first portion of a second frequency band, and transmit the second communication signal. The second converter is configured to receive a third communication signal that falls within the first portion of the second frequency band, frequency translate the third communication signal to a fourth communication signal that falls within the first frequency band, and transmit the fourth communication signal. The first portion of the second frequency band may include all or a portion of the second frequency band. According to this embodiment, the first and second frequency bands do not overlap.

According to a different embodiment of the present disclosure, a communication system includes a first wireless device, a first adapter, a second adapter, and a second wireless device. The first wireless device is configured to communicate over a first frequency band. The first adapter is configured to receive, from the first wireless device, a first communication signal that falls within the first frequency band, frequency translate the first communication signal to a second communication signal that falls within a first portion of a second frequency band, and transmit the second communication signal. The second adapter is configured to receive the second communication signal, frequency translate the second communication signal to a third communication signal that falls within the first frequency band, and transmit the third communication signal. The second wireless device is in communication with the second adapter and is configured to communicate over the first frequency band. The first portion of the second frequency band may include all or a portion of the second frequency band. In this embodiment, the first and second frequency bands do not overlap.

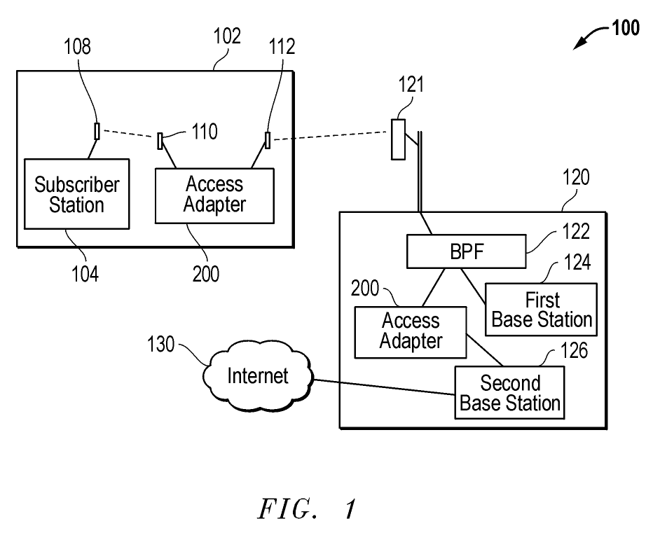

FIG. 1 shows an example wireless communication system 100 that employs multiple access adapters 200 configured according to various aspects of the present disclosure. Depending on the deployment, the adapters 200 may communicate via a wired or a wireless connection. In general, the access adapters 200 allow for the provisioning of broadband services to a subscriber station 104 using, at least in part, an existing communication system infrastructure. While only one subscriber station 104 is depicted in FIG. 1, it should be appreciated that multiple of the subscriber stations 104 may be employed within each customer premises 102. The subscriber station 104 may be, for example, a WiMAX capable computer system (such as a laptop computer, a mobile telephone, etc). Alternatively, the subscriber station 104 may implement a different wireless standard. In at least one embodiment, a transceiver (not shown in FIG. 1) of the subscriber station 104 is coupled to an antenna 108. In this embodiment, the subscriber station 104 communicates with a first access adapter 200 (deployed within the customer premises 102) over a first frequency band, such as a WiMAX band, via an antenna 110 that is coupled to the access adapter 200.

The first access adapter 200 frequency translates a first communication signal in the first frequency band to a second communication signal in a second frequency band, without modifying a protocol of the first communication signal. In at least one embodiment, the second frequency band corresponds to a cellular band in which a given telecommunication operator has acquired rights. The first access adapter 200 communicates with an integrated base station 120 via antenna 112, which is coupled to the first access adapter 200, and an antenna 121, which is coupled to the integrated base station 120. As is depicted, the antenna 121 is coupled to a bandpass filter (BPF) 122, which provides signals within a first portion (i.e., an available bandwidth) of the second frequency band to a second access adapter 200, co-located at the integrated base station 120, and signals within a second portion (e.g., an allocated cellular band) of the second frequency band to a first base station 124. The second access adapter 200 is coupled to a second base station 126, which is coupled to Internet 130, via, for example, an Internet service provider (ISP). In one embodiment, the first base station 124 is a cellular base station and the second base station 126 is a WiMAX base station.

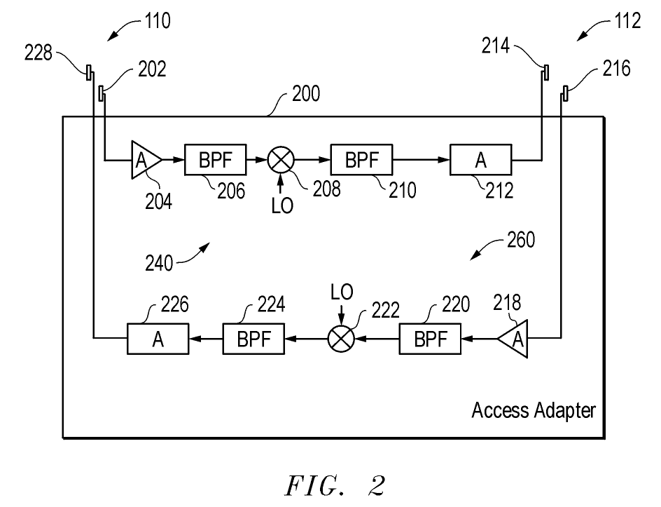

FIG. 2 shows the access adapter 200, which includes a first converter 240 and a second converter 260, in further detail. The first converter 240 includes an amplifier 204, a first bandpass filter (BPF) 206, a first mixer 208, a second BPF 210, and an amplifier 212. The second converter 260 includes an amplifier 218, a third BPF 220, a second mixer 222, a fourth BPF 224, and an amplifier 226. In at least one embodiment, the second BPF 210 and the fourth BPF 224 are configured to pass single side band (SSB) signals. It should be appreciated that the access adapter 200 may include additional functional blocks for performing additional functions. For example, one or more automatic gain control (AGC) loops may be employed within the access adapter 200 for power control and one or more processors may be employed for controlling various functionality of the adapter 200.

Antenna 202 is coupled to an input of the amplifier 204, whose output is coupled to an input the first BPF 206. The first BPF 206 is designed to pass all frequencies within a given first frequency band, such as a WiMAX band. An output of the first BPF 206 is coupled to a first input of the first mixer 208, whose second input receives a first local oscillator (LO) signal that is used to frequency translate (i.e., up-convert or down-convert) a first communication signal to a second communication signal. An output of the first mixer 208 is coupled to an input of the second BPF 210, whose output is coupled to an input of the amplifier 212. The second BPF 210 is designed to pass all frequencies within a given second frequency band, such as a cellular band. An output of the amplifier 212 is coupled to an antenna 214.

An antenna 216 is coupled to an input of the amplifier 218 of the access adapter 200. The antenna 216 is designed to receive a third communication signal that falls within the second frequency band. An output of the amplifier 218 is coupled to an input the third BPF 220. The third BPF 220 is designed to pass all frequencies within the second frequency band. An output of the third BPF 220 is coupled to a first input of the second mixer 222, whose second input receives a second local oscillator (LO) signal that is used to frequency translate, (i.e., down-convert or up-convert) the third communication signal to a fourth communication signal that falls within the first frequency band. An output of the second mixer 222 is coupled to an input of the fourth BPF 224, whose output is coupled to an input of the amplifier 226. The fourth BPF 224 is designed to pass all frequencies within the first frequency band, e.g., a WiMAX band. An output of the amplifier 226 is coupled to an antenna 228. Antennas 202 and 228 may be implemented as a single antenna, such as the antenna 110. Similarly, the antennas 214 and 216 may be implemented as a single antenna, such as the antenna 112. In the event that the antennas 202 and 228 are implemented as a single antenna, a first switch (not shown) may be employed to selectively switch the single antenna between receive/transmit. Similarly, in the event that the antennas 214 and 216 are implemented as a single antenna, a second switch (not shown) may be employed to switch the single antenna between transmit/receive. According to another embodiment, the adapter 200 may not employ antennas within associated communication paths. That is, the adapter 200 may hard-wired to one or more devices to which the adapter 200 communicates.

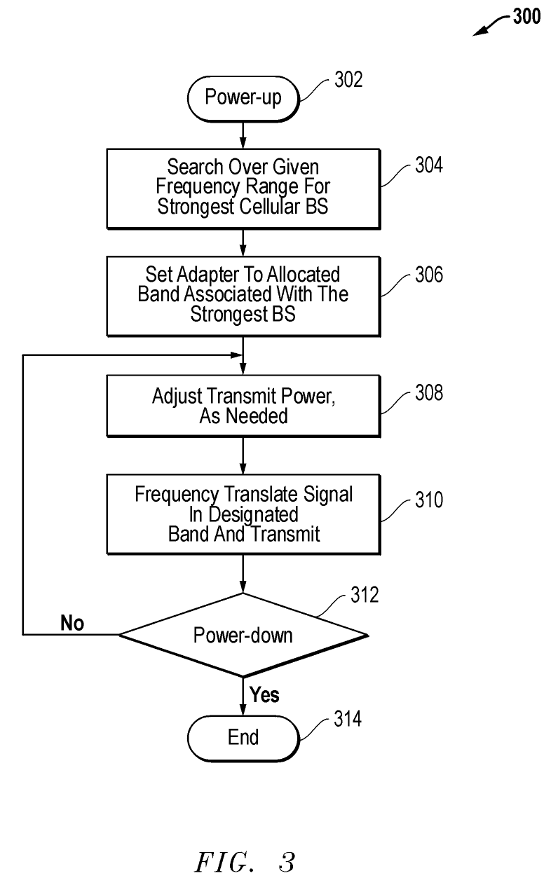

FIG. 3 shows an adapter operation process 300 that allows for the utilization of assigned frequency spectrum for new technologies that are not, prior to frequency translation, within the assigned frequency spectrum. In the discussion below, a WiMAX signal is assumed to be frequency translated for transmission over an available bandwidth in a cellular band. For example, assuming that the available bandwidth in the cellular band is equal to 20 MHz, an OFDM bandwidth for a WiMAX signal may be scaled to 20 MHz. It should be appreciated that the available bandwidth may change over time. In this case, the OFDM signal may be periodically scaled to efficiently utilize the available bandwidth. It should also be appreciated that the disclosed techniques are equally applicable to the frequency translation of signals other than WiMAX signals to an available bandwidth in frequency bands other than cellular bands. The process 300 is initiated at power-up of the adapter 200 in block 302. Next, in block 304 the adapter 200 searches over a given frequency range for a strongest cellular base station (BS). Then, in block 306, frequencies of the adapter 200 are set to an allocated frequency band that is associated with a strongest cellular BS.

Next, in block 308, the adapter 200 adjusts a transmit power, as needed. Then, in block 310, the adapter 200 transmits received signals in an appropriate manner. For example, when a received signal is in a designated WiMAX band, the adapter 200 translates the received signal to an available bandwidth in a cellular band and transmits the frequency translated received signal. Similarly, when a received signal is in an available bandwidth in a designated cellular band, the adapter 200 translates the received signal to a WiMAX band and transmits the frequency translated received signal. In this manner, a WiMAX compatible device can communicate over a cellular band. Next, in decision block 312, the adapter 200 determines whether power-down is indicated. If power-down of the adapter 200 is indicated in block 312, control transfers to block 314, where the process 300 ends. On the other hand, if power-down of the adapter 200 is not indicated in block 312, control transfers to block 308.

Accordingly, techniques have been described herein that advantageously facilitate implementation of wireless broadband systems using existing infrastructure and frequency bands that have already been allocated (or are readily available) to telecommunication operators.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of operating a communication system, comprising:
receiving a first communication signal that is assigned to a first frequency band;
frequency translating the first communication signal to a second communication signal that falls within an available bandwidth in a second frequency band, wherein the first and second frequency bands do not overlap; and
transmitting the second communication signal.

2. The method of claim 1, further comprising:
scheduling the first frequency band for the first communication signal based upon the available bandwidth in the second frequency band.

3. The method of claim 1, further comprising:
receiving a third communication signal that falls within the available bandwidth in the second frequency band;
frequency translating the third communication signal to a fourth communication signal that falls within the first frequency band; and
transmitting the fourth communication signal.

4. The method of claim 3, wherein the second frequency band is a cellular band and the first and fourth communication signals are IEEE 802.16 standard compliant orthogonal frequency division multiplex (OFDM) signals.

5. The method of claim 4, wherein the orthogonal frequency division multiplex (OFDM) signals are scalable.

6. The method of claim 1, further comprising:
bandpass filtering, prior to the frequency translating, the first communication signal; and
bandpass filtering, prior to the transmitting, the second communication signal.

7. The method of claim 3, further comprising:
bandpass filtering, prior to frequency translating, the third communication signal; and
bandpass filtering, prior to the transmitting, the fourth communication signal.

8. An access adapter for a communication system, the access adapter comprising:
a first converter configured to receive a first communication signal that falls within a first frequency band, frequency translate the first communication signal to a second communication signal that falls within a first portion of a second frequency band, and transmit the second communication signal, wherein the first and second frequency bands do not overlap; and
a second converter configured to receive a third communication signal that falls within the first portion of the second frequency band, frequency translate the third communication signal to a fourth communication signal that falls within the first frequency band, and transmit the fourth communication signal.

9. The access adapter of claim 8, wherein the first converter further comprises:
a first bandpass filter configured to substantially pass frequencies within the first frequency band;
a first mixer coupled to an output of the first bandpass filter, wherein the first mixer is configured to mix the first communication signal to the second communication signal; and
a second bandpass filter coupled to an output of the first mixer, wherein the second bandpass filter is configured to substantially pass frequencies within the second frequency band.

10. The access adapter of claim 9, wherein the second converter further comprises:
a third bandpass filter configured to substantially pass frequencies within the second frequency band;
a second mixer coupled to an output of the third bandpass filter, wherein the second mixer is configured to mix the third communication signal to the fourth communication signal; and
a fourth bandpass filter coupled to an output of the second mixer, wherein the fourth bandpass filter is configured to substantially pass frequencies within the first frequency band.

11. The access adapter of claim 8, wherein the second frequency band is a cellular band and the first and fourth communication signals are IEEE 802.16 standard compliant orthogonal frequency division multiplex (OFDM) signals.

12. The access adapter of claim 11, wherein the orthogonal frequency division multiplex (OFDM) signals are scalable.

13. The access adapter of claim 11, wherein the first and fourth communication signals are IEEE 802.16 standard compliant communication signals.

14. The access adapter of claim 8, wherein the first converter further comprises:
a first antenna coupled to an input of the first bandpass filter; and
a second antenna coupled to an output of the second bandpass filter.

15. The access adapter of claim 9, wherein the first converter further comprises:
a third antenna coupled to an input of the third bandpass filter; and
a fourth antenna coupled to an output of the fourth bandpass filter.

16. A communication system, comprising:
a first wireless device configured to communicate over a first frequency band;
a first adapter in communication with the first wireless device, wherein the first adapter is configured to receive a first communication signal that falls within the first frequency band from the first wireless device, frequency translate the first communication signal to a second communication signal that falls within a first portion of a second frequency band, and transmit the second communication signal, wherein the first and second frequency bands do not overlap;
a second adapter in communication with the first adapter, wherein the second adapter is configured to receive the second communication signal, frequency translate the second communication signal to a third communication signal that falls within the first frequency band, and transmit the third communication signal; and
a second wireless device configured to communicate over the first frequency band, wherein the second wireless device is in communication with the second adapter.

17. The communication system of claim 16, further comprising:
an antenna; and
a filter coupled between the antenna and the second adapter, wherein the filter is configured to substantially pass frequencies within the first portion of the second frequency band to the second wireless device, and wherein the first wireless device is a subscriber station and the second wireless device is a first base station.

18. The communication system of claim 17, further comprising:
a second base station coupled to the filter, wherein the second base station is configured to communicate over a second portion of the second frequency band and the filter is further configured to substantially pass frequencies within the second portion of the second frequency band to the second base station.

19. The communication system of claim 16, wherein the second frequency band is a cellular band and the first and third communication signals are orthogonal frequency division multiplex (OFDM) signals.

20. The communication system of claim 19, wherein the orthogonal frequency division multiplex (OFDM) signals are scalable and are IEEE 802.16 standard compliant communication signals.
